(19) United States
(12) Patent Application Publication
(10) Pub. No.: US 2004/0125416 A1
(43) Pub. Date: Jul. 1, 2004

(54) Method of scanning an image with an electronic scanner

(76) Inventors: Noah J. Gawlik, Lexington, KY (US); Brian K. Owens, Lexington, KY (US); Donald N. Spitz, Lexington, KY (US); Gregory P. Washnock, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/330,709

(22) Filed: Dec. 27, 2002

(51) Int. Cl. H04N 1/04

(52) U.S. Cl. 358/474; 358/486

(57) ABSTRACT

A method of scanning an image with an electronic scanner. A print medium or a scan bar is moved in an advance direction at an advance velocity. An image on the print medium is scanned using the scan bar. Scan image data is outputted from the scan bar to a buffer memory. A capacity level of the buffer is monitored at discrete points in time. A rate of change of the capacity level over time is determined. The advance velocity is controlled, dependent upon the rate of change.

### BACKGROUND OF THE INVENTION

1. Field of the Invention

The present invention relates to image scanners, and, more particularly, to a method of storing scan image data in such an image scanner.

2. Description of the Related Art

One of the speed-limiting factors for a PC attached scanner is the data transfer rate from the scanner to the PC. Most scanners on the market today utilize a small buffer to store the data in while it is waiting to be sent to the PC through a USB interface. If the scanner is acquiring data at a higher rate than the scanner-to-PC data transfer rate, then the small data buffer will fill up. Scan motion will be paused until sufficient data has been transferred to free up memory space. Typically, on flatbed scanners if the memory fills, then the carriage is returned to a short distance before scanning was stopped so that the carriage can reach a steady-state velocity before scanning resumes. Sheet-fed or auto document feeder scanners, however, typically only move the paper in one direction. If the buffer fills up then the paper motion is stopped until sufficient data has been transferred and then paper motion continues. Problems can occur when data is collected while the paper decelerates and then while it accelerates to steady-state again. This stopping of the system, where there is no provision for returning to steady-state before collecting more data, tends to cause significant errors in the vertical scan quality. One solution is to decrease the scanning speed to a point that a sustained data transfer rate would be sufficient; however, this adversely affects the speed of the scanner since it would need to be set for the slower end of the computer spectrum. Another solution would be to increase the buffer size; however, this becomes cost prohibitive especially at higher scan resolutions.

What is needed in the art is an image scanner which controls the rate of scanning such that the print medium and scan bar are not stopped relative to each other during scanning.

### SUMMARY OF THE INVENTION

The present invention provides a method of scanning an image in which scan image data is stored in a buffer, the capacity level of the buffer is monitored, and the advance velocity of the print medium (and in turn the scan velocity) is controlled dependent on the capacity level of the buffer. The rate of change of the capacity level may also be monitored for controlling the advance velocity of the print medium.

The invention comprises, in one form thereof, a method of scanning an image with an electronic scanner. A print medium or a scan bar is moved in an advance direction at an advance velocity. An image on the print medium is scanned using the scan bar. Scan image data is outputted from the scan bar to a buffer memory. A capacity level of the buffer memory is monitored. The advance velocity is controlled, dependent upon the monitoring step.

The invention comprises, in another form thereof, a method of scanning an image with an electronic scanner. A print medium or a scan bar is moved in an advance direction at an advance velocity. An image on the print medium is scanned using the scan bar. Scan image data is outputted from the scan bar to a buffer memory. A capacity level of the buffer is monitored at discrete points in time. A rate of change of the capacity level over time is determined. The advance velocity is controlled, dependent upon the rate of change.

An advantage of the present invention is that the image is scanned without stopping movement of the print medium in the advance direction, thereby improving scanning quality.

Another advantage is that the advance velocity of the print medium can be controlled based upon the capacity level of the buffer, or the rate of change of the capacity level of the buffer.

Yet another advantage is that multiple threshold values may be used corresponding to different capacity levels of the buffer to variably control the advance velocity.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic illustration of an electronic scanner which may be used to carry out the method of scanning of the present invention;

FIG. 2 is a schematic illustration of the capacity levels of the buffer in one embodiment of the scanning method of the present invention; and

FIG. 3 is a schematic illustration of an embodiment of inhibiting hysterysis in the scanning method of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

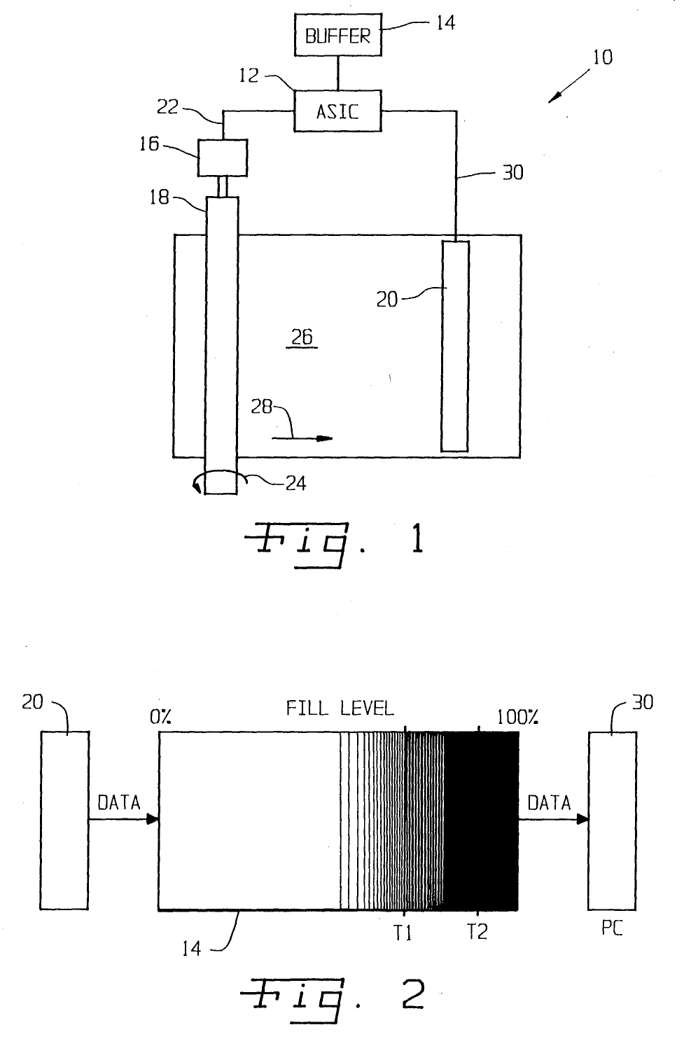

Referring now to the drawings, and particularly to FIG. 1, there is shown a schematic illustration of an electronic scanner 10 which may be used to carry out the method of scanning an image of the present invention. Scanner 10 generally includes an application specific integrated circuit (ASIC) 12, buffer memory 14, paper feed motor 16, paper feed roller 18 and scan bar 20.

ASIC 12 is electrically connected with and controls operation of paper feed motor 16 via line 22. Paper feed motor 16 is coupled with paper feed roller 18, and rotatably drives paper feed roller 18 as indicated by rotational arrow 24. Paper feed roller 18 frictionally engages print medium 26, such as paper, and advances print medium 26 in an advance direction at a scan or advance velocity V corresponding to a nominal operating velocity. Paper feed motor 16 may be controlled to provide a variable output which in turn varies the advance velocity of print medium 26, as will be described in more detail hereinafter.

ASIC 12 is also electrically connected with scan bar 20 via line 30, and receives scan image data from scan bar 20 during a scanning operation. The scanned image data is stored in buffer 14 for subsequent use or outputting to attached electronic equipment, such as a personal computer (PC). Of course, the exact input/output (I/O) configuration associated with ASIC 12 and buffer 14 may vary depending on the application.

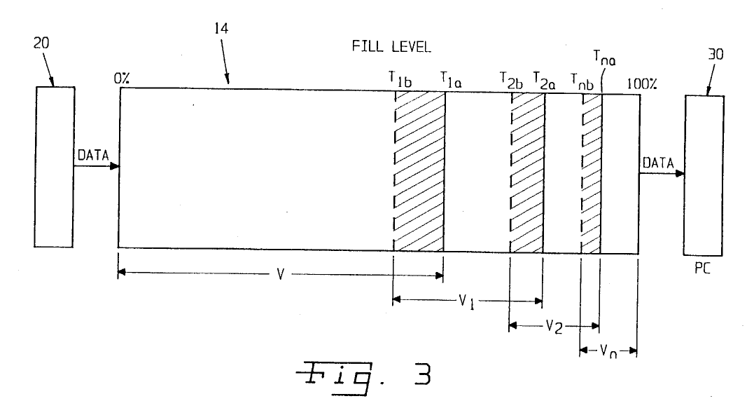

Referring now to FIG. 2, there is shown a schematic illustration of the capacity levels of the buffer as it pertains to one embodiment of the scanning method of the present invention. Scan bar 20 scans an image on print medium 26 and outputs scan image data to buffer 14. Buffer 14 may have any suitable maximum capacity corresponding to a full level of scan image data which is received from scan bar 20. In other words, the full level is at 100% capacity level of buffer 14. A first threshold T1 corresponds to a predetermined portion of the full level of buffer 14. A second threshold T2 also corresponds to a predetermined portion of the full level of buffer 14. Second threshold T2 is assigned a value which is greater than first threshold T1. Of course, the values of first threshold T1 and second threshold T2 relative to the full level of buffer 14 can vary depending on the application. Further, it is also possible to use a single threshold value or more than two threshold values, depending on the application.

During a scanning operation, paper feed motor 16 is operated at a nominal rotational output speed which in turn drives paper feed roller 18 with a circumferential velocity corresponding to the nominal scan velocity V of print medium 26. Paper feed roller 18 frictionally engages print medium 26 and thus advances print medium 26 in advance direction 28 at nominal scan velocity V. Print medium 26 includes an image thereon to be scanned. Scan bar 20 scans the image as print medium 26 moves therepast at the nominal scan velocity V and outputs scan image data to buffer 14. ASIC 12 monitors the capacity level of buffer 14. If the capacity level of buffer 14 exceeds first threshold T1, then the rotational speed of paper feed motor 16 is decreased, which in turn reduces the scan velocity of print medium 26 to scan velocity V1 which is less than nominal scan velocity V. If buffer 14 continues to fill to a point such that the capacity level exceeds second threshold T2, then the rotational output speed of paper feed motor 16 is further decreased to a second scan velocity V2 which is less than scan velocity V1. The data transmission rate for buffer 14 to PC 30 should then exceed the rate at which buffer 14 is filled with scanned image data outputted by scan bar 20. When the capacity level of buffer 14 falls below first threshold T1, paper feed motor 16 is accelerated to nominal scan velocity V. Of course, a suitable Algorithm is employed to ensure that the rotational output speed of paper feed motor 16 does not repeatedly bounce between nominal scan velocity V, scan velocity V1 and scan velocity V2 (i.e., to inhibit hysterysis). Moreover, a suitable algorithm is also employed to ensure that paper feed motor 16 is properly accelerated and decelerated between nominal scan velocity V, scan velocity V1 and scan velocity V2.

Referring now to FIG. 3, one method of enabling hysterysis in the method of scanning of the present invention will be described in greater detail. Scan bar 20 scans the image at a nominal scan velocity V and outputs scan image data to buffer 14. Multiple thresholds are used defining zones of overlapping scan velocities such that hysterysis is enabled. More particularly, as the fill level of buffer 14 reaches first threshold T1a, the scan velocity is reduced to scan velocity V1. If the scan velocity V1 is slow enough such that the fill level of buffer 14 begins to decrease, then the scan velocity is again increased to nominal scan velocity V when the fill level decreases to threshold T1b. On the other hand, if the fill level of buffer 14 continues to increase, then the scan velocity is further slowed to second scan velocity V2 at second threshold T2a. At the slower, second scan velocity V2, the fill level of buffer 14 may begin to decrease. When the fill level decreases to threshold T2b, the scan velocity is accelerated to scan velocity V1. On the other hand, if the second scan velocity V2 continues to supply scan image data faster than the transfer rate to PC 30, then the scan velocity is decelerated to scan velocity Vn when the fill level reaches Tna. This process continues, depending upon how many threshold values and scan velocities are used in a particular application.

Rather than using discrete threshold values as described above with regard to first threshold T1 and second threshold T2, it is also possible to monitor the capacity level of buffer 14 at a predetermined sampling rate over time and determine a rate of change of the capacity level over time. In this way, if the capacity level buffer 14 is quickly changing then the rotational output speed of paper feed motor 16, and in turn the scan speed, can also change quickly to dynamically modify the scan rate of scanner 10. One method of determining the rate of change of the capacity level is to calculate the derivative of a change in the capacity level over time.

In the embodiment of the scanning method of the present invention as described above, the rotational output speed of paper feed motor 16 is controllably varied to in turn vary the advance velocity of print medium 26. However, it is also to be appreciated that the scanning method of the present invention can likewise be applied to a flat bed scanner having a movable scan bar. In the case of a flat bed scanner, the translational scan velocity of the scan bar is controllably varied depending upon the capacity level of the buffer memory, as described above.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of scanning an image with an electronic scanner, comprising the steps of:
moving one of a print medium and a scan bar in an advance direction at an advance velocity;
scanning an image on the print medium using said scan bar;
outputting scan image data from said scan bar to a buffer memory;
monitoring a capacity level of said buffer memory; and
controlling said advance velocity, dependent upon said monitoring step.

2. The method of scanning an image of claim 1, wherein said buffer memory has a full level, and including the further steps of:
assigning a first threshold T1 corresponding to a predetermined portion of said full level of said buffer memory; and
decreasing said advance velocity to a scan velocity V1 when said capacity level reaches said first threshold.

3. The method of scanning an image of claim 2, wherein said advance velocity is set at a nominal scan velocity V when said capacity level is below said first threshold T1.

4. The method of scanning an image of claim 3, wherein said decreasing step comprises decelerating said advance velocity from said nominal scan velocity V to said scan velocity V1 at a known deceleration.

5. The method of scanning an image of claim 2, including the further steps of:
assigning a second threshold T2 corresponding to a predetermined portion of said full level of said buffer memory, said second threshold T2 being greater than said first threshold T1; and
decreasing said advance velocity to a scan velocity V2 when said capacity level reaches said second threshold T2, said scan velocity V2 being less than said scan velocity V1.

6. The method of scanning an image of claim 1, wherein said monitoring step comprises:
monitoring said capacity level at discrete points in time; and
determining a rate of change of said capacity level over time.

7. The method of scanning an image of claim 6, wherein said step of determining said rate of change includes calculating a derivative of a change in said capacity level over time.

8. The method of scanning an image of claim 1, wherein said step of controlling said advance velocity includes selecting one of a plurality of advance velocities, and enabling hysterysis between said plurality of advance velocities during said controlling step.

9. The method of scanning an image of claim 1, wherein said scanner includes a paper feed motor, and said controlling step includes controlling a rotational output speed of said paper feed motor.

10. The method of scanning an image of claim 1, wherein said scanner comprises one of an automatic document feed scanner and a flat bed scanner.

11. A method of scanning an image with an electronic scanner, comprising the steps of:
moving one of a print medium and a scan bar in an advance direction at an advance velocity;
scanning an image on the print medium using said scan bar;
outputting scan image data from said scan bar to a buffer memory;
monitoring a capacity level of said buffer memory at discrete points in time;
determining a rate of change of said capacity level over time; and
controlling said advance velocity, dependent upon said determination of said rate of change.

12. The method of scanning an image of claim 11, wherein said step of determining said rate of change includes calculating a derivative of a change in said capacity level over time.

13. The method of scanning an image of claim 11, wherein said step of controlling said advance velocity includes selecting one of a plurality of advance velocities, and enabling hysterysis between said plurality of advance velocities during said controlling step.

14. The method of scanning an image of claim 11, wherein said scanner includes a paper feed motor, and said controlling step includes controlling a rotational output speed of said paper feed motor.

15. The method of scanning an image of claim 11, wherein said scanner comprises one of an automatic document feed scanner and a flat bed scanner.

16. A method of transmitting scan image data from an image scanner to a computer, comprising the steps of:
scanning an image with said image scanner, comprising the sub-steps of:
moving one of a print medium and a scan bar in an advance direction at an advance velocity;
scanning the image on the print medium using said scan bar;
outputting scan image data from said scan bar to a buffer memory;
monitoring a capacity level of said buffer memory; and
controlling said advance velocity, dependent upon said monitoring step; and
transmitting said scan image data from said buffer memory to the computer.
